(19) United States
(12) Patent Application Publication
(10) Pub. No.: US 2022/0171444 A1
(43) Pub. Date: Jun. 2, 2022

(54) APPARATUS FOR DEVICE CHARGING

(71) Applicant: IFPL GROUP LIMITED, Isle of Wight (GB)

(72) Inventor: Geoffrey Paul UNDERWOOD, Isle of Wight (GB)

(21) Appl. No.: 17/600,872

(22) PCT Filed: Apr. 2, 2020
(86) PCT No.: PCT/EP2020/059457

§ 371 Date: Oct. 1, 2021

(30) Foreign Application Priority Data
Apr. 2, 2019 (GB) 1904638.2

(51) Int. Cl. G06F 1/26; H04L 67/141; G06F 3/0484; B60R 16/03

(52) U.S. Cl. CPC G06F 1/26; H04L 67/141; G06F 3/0481; B60R 16/03; G06F 3/0484

(57) ABSTRACT

A connector outlet (1) for permitting control of a power supply for charging a user's portable electronic device, PED, such as a mobile telephone, portable computer or table, and providing passengers with the facility of a device charging service, and/or access to a data network through use of a credential provided from the PED to the outlet.

### TECHNICAL FIELD

The present invention relates to improvements concerning controlling charging of a battery of a portable electronic device and/or controlling a data network connection to a portable electronic device.

### BACKGROUND

Portable electronic devices require electrical power to operate. Mobile devices such as tablets, portable computers and mobile phones typically include a rechargeable battery that is recharged when the device is plugged into a socket capable of delivering power to the device. Rechargeable batteries must be charged from an external power source regularly to maintain battery life because rechargeable batteries discharge even when not used. The users of the mobile devices often suffer due to inaccessibility of electrical power for battery charging. In such a situation, the user must carry multiple batteries for continued operation of the mobile device or have access to an external power supply. Requiring a user to carry backup batteries not only incurs the expense of the additional battery but requires transport space and increased transport expense.

We have devised improved ways in which a passenger can conveniently re-charge his mobile device by way of a payment token which provides a credit for activating a power charging or data connection service or facility.

### SUMMARY

According to the first aspect of the invention there is provided an apparatus for controlling an interface for coupling to a portable electronic device, PED, the apparatus comprising a processor and a switch, and the switch arranged to control power supplied to the interface and/or a data connection via the interface, the processor configured to receive a signal and the processor arranged to control the switch to selectively determine to allow power and/or data to be delivered through the interface to a coupled PED, and the signal input comprises an indication of a media having been rendered and output by the PED.

The apparatus may be arranged or suitable for installation in a (public or mass) transport vehicle, for example a passenger cabin of an aircraft, or other form of transportation. However, the apparatus could be used in numerous other contexts, in addition to transportation, such as public areas, shops, cafes etc. In fact anywhere it may be convenient to charge a PED.

The processor may be arranged to effect a handshake protocol of signalling or one or more messages or messaging exchanges with the PED so as to establish communication between the PED and the processor.

The processor may comprise circuitry embodied as or in a PCB (printed circuit board). The processor may be provided with executable operational instructions (such as software or firmware). The processor may comprise a programmable logic array.

A memory may be provided associated with operational use of the processor.

The processor may be configured to receive a signal indicative of a credential stored on or generated by the PED, in order to at least in part to cause the processor to control the switch. The credential may comprise a token, a (unique) digital identifier or a code. The credential may be encoded or encrypted. The processor may be configured to perform public/private key methodology to ascertain the validity of the credential. The credential may comprise a digital object. The credential preferably comprises identifying data. The credential may be viewed as a token which provides credit for a mobile device charging service, or a service allowing access to a data network or data resource. The credential may be described as a charging token, or a data token.

The processor may be configured to compare an identifier in the signal with a stored identifier, or the identifier to be subject to a decryption methodology so as to validate control of the switch to allow power and/or data access through the interface.

The processor may require that at least a predetermined proportion of the time length of the media is rendered and output before the processor can act so as to control the switch to allow connectivity to power and/or data through the interface. The processor may be arranged to require that it receives a signal providing an indication of the at least predetermined portion having elapsed, or that it makes a determination of the same.

The interface may be arranged to communicate with the PED by a hard-wired or cable connection or physical carrier. Alternatively, or in addition, the interface may be arranged to communicate the PED by way an air interface, such as Bluetooth® or Wi-Fi communications protocols.

The processor may be configured to permit access to a data network or data resource to allow the media to be downloaded onto a memory of the PED.

The apparatus may be arranged to receive the signal through the interface, or through a different communication interface.

The signal may be indicative of a credit value which allows multiple charging instances or charging service events.

The processor may be configured to process the signal to determine whether the signal corresponds to a valid credential.

The processor may provide intelligent functionality at the interface, or be in communication with the interface.

The expression ‘interface’ is intended to be understood broadly, and its meaning includes a connector port, such as a socket, which requires a wired or cable connection to the PED, and includes a communication with the PED over on air interface, such as data and signalling sent by Bluetooth® or Wi-Fi, or power transferred by inductive charging.

The interface may comprise a USB socket. Generally, the connector port preferably allows a counterpart connector (such as a plug) to be physically connected thereto, and provide an electrical signal connection. The interface may comprise a power outlet and/or a data port. The interface may comprise a number of electrical contacts or electrical terminals arranged to come into contact with a counterpart connector.

An apparatus which comprises a processor an interface may be termed a power charging outlet.

The outlet may be described as a PULL-based system, in that a PED plugged into or coupled with, the outlet determines the response of the outlet. This is contrary to the convention especially (although not necessarily only) in aircraft since typically an outlet prescribes what it can give and that is what the device gets.

The outlet may be arranged to be switched to an in-use condition by the PED.

It will however be appreciated that the PED may determine the magnitude of charge, or more generally the delivered power characteristics. This may be such that the outlet is arranged to receive and act upon a charging control signal output by the PED. The charging characteristics may include charging magnitude, a sequence of different charging magnitudes and/or total charging/power delivered to a PED. The outlet may be arranged to monitor voltage and/or current in relation to the battery of the PED being charged, and tailor/regulate the supplied charging power/charge characteristics accordingly.

It will be appreciated that power may always available to the outlet (although not from the outlet to a PED unless/until a credential is supplied). The outlet is preferably never OFF unless it is broken or there is no power feeding it. The outlet may be arranged to deliver ˜100 mA (or more generally a non-zero positive amount) enabling low rate trickle charging and the outlet also allows a fully discharged device to communicate with the outlet.

The outlet may be arranged to differentiate between different types of device which are connected or coupled to it:

(1) For a PED or similar charging power is supplied based on receipt of credential stemming from the App (e.g. payment credential, advertisement etc.)

(2) For ‘non—intelligent’ devices (e.g. power bank, camera etc) a credential may not be required for charging (although an outlet connector port may only deliver power to such a device if a credential had previously been supplied by a connected PED).

The invention may be viewed as comprising an intelligent power outlet.

It will be appreciated that the outlet may comprise a number of power outlet connector ports (i.e. two or more). This may enable multiple devices to be charged simultaneously.

Carrier ‘locking’ may be applied to the outlet. For example, the user may not be able to use an App for airline X to activate an outlet on an aircraft of airline Y—i.e. the App may be carrier specific. Furthermore, the outlet may be configured according to carrier (specific requirements).

The outlet may be also configured to a specific tail fin number of the aircraft into which it is fitted/to be fitted. This latter feature enables an airline to establish which routes are profitable as well as which routes suffer more customer-induced damage.

The outlet may be identified to an individual seat/airline ID.

The outlet may comprise a visual indicator, illumination or light, and the colour output thereby may be configured according to carrier preferences (for example a particular in accordance which airline branding colour(s)).

The outlet may not necessarily be required to connect to an upstream ‘intelligent’ host e.g. a server—it may (simply) need to be connected to a power supply. If a PED is plugged into the outlet and there is no App on the PED, the PED may automatically be pointed at an appropriate (resource) location to obtain/download the App either on the carrier WiFi or at a ‘ground’ station.

It will be appreciated that the outlet is not limited to comprising a USB type A outlet port, the outlet may be arranged to operate all USB types, Inductive Charging and/or (other) over-air charging systems. The outlet may comprise multiple connector ports.

For an outlet utilising a USB-C connector, or other connectors using more advanced communication protocols than provided by the standard 4 pin USB devices, the communication channels (for signalling, data transfer and/or messaging etc.) between the PED and the outlet may be arranged to use the an array of communication channels including, but not limited to, the standard data channels D+ and D−, the CC channels and the Alternate Mode communication channels.

The outlet may advantageously be capable of being configured (e.g. for installation and commissioning purposes) without needing to return it to the factory or to the maintenance department, thus enabling the airline/carrier to conveniently configure the unit independently thereof. Configuration options/settings may include one or more of the following:
(1) Configurable to be individually wirelessly via Bluetooth®
(2) Shipset or carrier groups (first class, business, economy for example) configurable en masse via an on-board server or via Bluetooth Mesh (allowing many-to-many air interface communication).
(3) configurable via the App on a smartphone, wherein the App includes to have a user mode and a maintenance/administrator mode
(4) May be configurable by scanning a QR Code, barcode or similar graphical coding method with a smartphone (or similar device)

The outlet may advantageously provide a number of reporting tools. These may include one, some or all of the following:
(1) Reporting to a local plugged-in smartphone, to a USB (e.g. a solid-state memory device) inserted into the device, via Bluetooth and/or via a server if connected thereto via a wired or wireless system
(2) The outlet may be capable of recording (in its readable memory) one, some or all of the following:
i) amount of charge delivered by the outlet
ii) identification of the type of device connected
iii) identification of the supply voltage
iv) count or the number of insertions of any PED into the outlet (which thereby may enable operational lifetime monitoring)
v) an established the hardware status—ie charging/non-charging, effectiveness of the hardware—(e.g. is it breaking/failing, may be likely to fail)
vi) min/max temperature of the PCB (embodying/carrying the processor of the outlet) useful for fault identification and excessive hot conditions (ie touch temperature of passenger facing surfaces is controlled by regulation—for inductive charge the temperature can be monitored, and power backed off to keep touch temperature within limits)

The outlet may have a list of so-called ‘Gets’ and ‘Sets’, as now described, these are various informational or data items which can be sent to or retrieved from a memory of the outlet.

GETs—the information (one, some or all of the list below) that may be retrieved from the outlet by using the maintenance app either on a server, on a USB or via a PED plugged into the outlet:

Serial number (of outlet)

Software revision number

Temperature of board(s) (i.e. PCBs of the outlet)

Compilation time of firmware

Compilation date of firmware

Supply Voltage (Now/Min/Max)

Output voltage (Now/Min/Max)

Current being drawn (Now/Min/Max)

Total charge so far

Remaining charge time

Hardware status

Number of times the unit has been used. (Plug cycles)

Plane's Identity data

Seat ID number

Real Time Clock data (GMT)

Time Zone offset

Airline ID data

IP Address for location of App. (For use with on board aircraft server via wifi)

SETs—the information that can be sent to the outlet for configuration of the outlet by using the maintenance app either on a server, on a USB or via a PED plugged into the unit (one, some or all of the following items):

Send Key

Duration to charge for (seconds)

LED Colour(s)

Free Issue i.e. activate the outlet ON indefinitely. (e.g. for First class/Business cabin passengers)

Plane ID data

Seat ID number

Engineer access code

Real Time Clock (GMT)

Time Zone offset Airline ID Data

IP Addr for location of app ((For use with on board aircraft server via wifi) Engineer access only.

According to a second aspect of the invention there is provided a passenger vehicle, which comprises a passenger seat, a connector port for connection to a portable electronic device, PED, of a passenger to be charged/powered or to be connected to a data connection provide through the connector port, the connector port arranged at or in close proximity to the passenger seat, a control apparatus for controlling the connector port, the control apparatus comprising a processor and a switch, the switch arranged to control power supplied to the connector port and/or a data connection via the connector port, the processor arranged to receive a signal, and the processor configured to control the switch at least in part on dependence on the signal, and the signal indicative of a media having been rendered and output by the PED.

The connector port may be provided at or in close proximity to the passenger seat. The connector port may be provided at a rearward portion of the passenger seat. The connector port may be fixed/installed into any convenient location within a passenger seat i.e. arm, backrest, tray table, visual display of an In Flight Entertainment system.

According to a third aspect of the invention there is provided a software application for installation onto a user portable electronic device, PED, and the software application comprises instructions to determine when the PED is connected to an interface to deliver power and/or to provide access to a data network or data resource, the application arranged to cause the device to be capable of storing media or a link to media, and the application comprises instructions which cause the rendering of the media by the device, and further comprising instructions which determine when the media has been rendered, and so cause the device to output a signal which is indicative of that to a processor which controls the interface.

The rendering of the media may include playing and displaying the media.

The media may comprise audio-visual material, audio material and/or visual material. The media may comprise an advertisement, or publicity or marketing material. The media may comprise video.

The software application may comprise instructions to effect a messaging/signalling protocol, or handshake, to establish communication between the PED and the processor and/or to negotiate data and/or power access through the interface.

The software application may comprise instructions to access a data resource or data network to download a file of the media. The software application may comprise instructions to download a file of the media from a stored resource location.

The software application may comprise instructions to output a resource location of the media, or an identifier of the media within a data resource. The resource location may comprise a URL.

The software application may be arranged to manage the GETs and SETs (in relation to managing/enabling read access to a memory of the outlet and/or write access to a memory of the outlet) between a PED (or other connected device) and the outlet.

The software application may be configured to store a passenger boarding pass or ticket.

The software application may comprise instructions to generate a graphic user interface, GUI, which includes a prompt to a user to provide an input as to whether he/she would like to proceed to charge or power the device and/or access the data network.

The software application may comprise instructions to output a signal which is indicative of at least a predetermined portion or extent of the media is rendered by the device. The software application may comprise a video viewer module.

The software application may be configured to output the signal when the entirety of the media has been rendered and output by the PED.

The software application may comprise or control a module for rendering audio-visual data.

The software application and/or the processor may be arranged to update a (credit) value or balance associated with the credential stored on the device, for example when a user has used a credential for an instance of charging the device.

The application may be arranged to cause the PED to store multiple one-time use credentials or tokens.

The software application may comprise machine-readable instructions arranged to be executed by a processor of the PED.

The software application may comprise a software product.

According to another aspect of the invention there is provided a method of controlling access for a portable electronic device to a power supply and/or access to a data network or data resource through an interface, the method comprising controlling access to power and/or data provided by an interface which is external of a PED, wherein, access criteria includes at least that a media has been rendered and output by the PED.

The invention may be viewed as a method of activating a power charging facility or a data connection service, accessible through a connector port.

According to yet a further aspect of the invention there is provided a digital object which comprises a transportation boarding pass and a media file or link to a media file which contains audio-visual material. The transportation boarding pass may comprise a passenger boarding pass for an aircraft.

A digital object which is arranged to be loaded onto a memory of PED, which comprises media or a link to media, for use with other aspects of the invention.

Any of the above aspects of the invention may include one or more features described in the description or shown in the drawings, either individually or in combination.

### BRIEF DESCRIPTION OF THE DRAWINGS

Various embodiments of the invention will now be described, by way of example only, with reference to the following drawings in which:

FIG. 1 is a block diagram of the principle functional components of a device charging system;

FIG. 2 is a block diagram of a mobile device which comprises a software application to enable use of the device charging system of FIG. 1;

FIG. 3 is a schematic diagram of an aircraft passenger seat in which the device charging system of FIG. 1 has been implemented,

FIG. 4 is a flow diagram showing the process steps allowing a portable electronic device to connect to a power supply, and

FIG. 5 is an infographic illustrating the steps set out in FIG. 3

### DETAILED DESCRIPTION

There now follows a description of various implementations of arrangements for permitting control of a power supply for charging a user's portable electronic device, PED, such as a mobile telephone, portable computer or tablet. In the implementations below, the invention is applied in the context of an aircraft cabin, providing passengers with the facility of a device charging service, and/or access to a data network. However, it will be appreciated that reference to ‘passenger aircraft’ could be replaced more generally with passenger transport vehicle, such as trains, coaches, ships etc.

As will be explained in more detail below, a requirement for a passenger to have power supplied to his/her PED connected to a socket is that a media must be rendered and output by the PED, either for a predetermined time or the entirety of the media. The media is an advertisement or promotional material in audio-visual form.

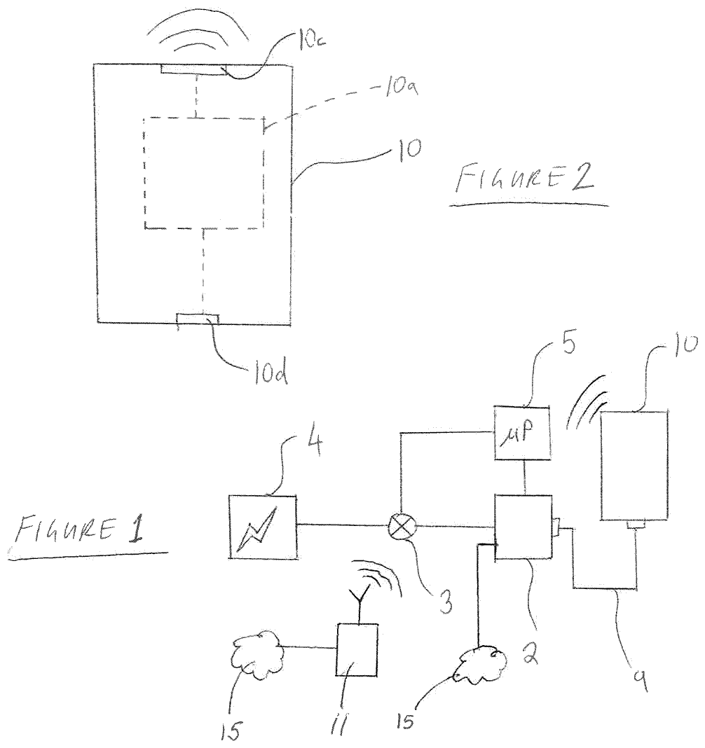

Reference is first made to FIG. 1 which shows a block diagram of the principle modules and sub-assemblies of a passenger device charging system. The system comprises a socket 2, a switch 3, a power source 4, and a processor 5.

The socket 2 is a USB-type socket (although other socket types could be used whilst still implementing the invention) which is arranged to receive a counterpart plug or connector, which in turn is connected to a passenger's PED, and to thereby provide charging power to re-charge the battery of the device.

The socket 2 is connected to the power supply 4 via a switch 3. The power supply is that which is provided onboard the aircraft (and deriving its power from the aircraft's engines), and is modulated and regulated by suitable power control and distribution circuitry and sub-assemblies (such as an inverter).

The switch 3 is controlled by the processor 5. The processor 5 is provided with instructions (either as software or firmware) to control/determine the operative state of the switch i.e. whether to allow the socket to be provided with power or not, and other criteria such as for how long and under what conditions.

The processor 5 is arranged to receive and process credential data from a device connected to the port. It will be appreciated that the processor 6 may be provided as an integral part of the port, and as such may be viewed as providing the terminal with intelligent functionality.

The socket 2 is located in the proximity of the passenger, such as in an armrest, or in portion (such as a cut-out) of the rearward part of the seat or in a bulkhead in front of the passenger. In broad terms, the socket 2 is located in an accessible position for the passenger.

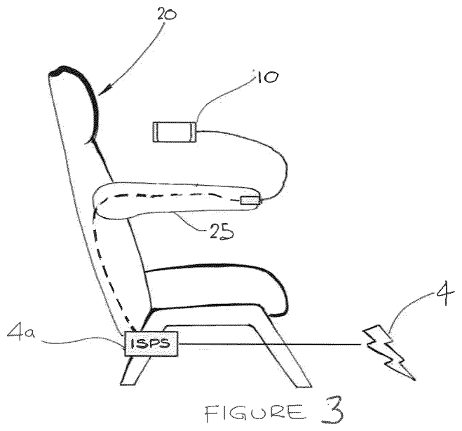

In one implementation, the PED is a smartphone which has loaded onto its memory an app software application. Reference is made to FIG. 2 which shows a mobile telephone 10 which includes a software application 10a, such as in form an App, which is such as to be able to:
download a media file from a link (such as a URL) stored in a memory of the PED, and
render and output the downloaded media file on the PED, and
cause the PED to output a signal indicative of all or a predetermined

The device 10 comprises an interface 10c for communication over an air interface, and a port 10d for connection to a cable for receiving a charging power supply externally.

The software application 10a contains instructions which (in part) manage the device charging service and controls the switch 3.

The interface 10c may comprise an aerial or inductive loop which can be suitably energised under the control of the application 10a.

The software application 10a, in use, either stores or generates a credential, contained within the signal, which is output to the processor 5. The processor 5 is configured to process the received signal to determine whether the credential is valid or invalid and to activate power being supplied to the socket or power outlet 2 by controlling the switch 3.

A user of the PED would first install the software application onto the device 10. In the case of implementation of the invention in the context of air travel, the user would install the software application prior to the time of travel. At the time of installing the software application 10a, during an update or when the user downloads a boarding pass on an airline's website to check-in, a link to a media is caused to be stored in the memory of the device. This may be in form of a URL, which points to an audio-visual file or content.

On boarding the aircraft and taking the seat, the passenger wishes to power or charge the PED. This involves the user connecting a cable from the connector 10d of the PED to the connector 2. On making this connection, a characteristic or residual voltage is determined as being present by the software application 10a. This may then involve the application bringing about a handshake protocol to establish communication between the PED and the processor 5, via the socket 2. The instructions of the software application 10a then cause a GUI to presented to the user. This may include text such as:

‘DO YOU WISH TO CONNECT TO THE ONBOARD POWER SUPPLY?’

The GUI allows the user to input a response of ‘YES’ or ‘NO’, or equivalent.

On selecting YES, the software application retrieves the URL link (or media itself) which is stored within a memory of the device. The software application then uses the predetermined messaging protocol to send the URL via the cabled connection and the connector port 10d to a data resource. This may include a connection to a server accessible through the internet 15. However, the media file(s) may be stored within a memory which is located onboard the aircraft and which is accessible via LAN.

In an alternative embodiment, a WLAN may be provided which permits the URL to be loaded from the network (or localised data storage) by way of a wireless connection, instead of through a data connection provided by the socket. By way of example, a wireless hub or node 11 is provided which provides connection to the Internet. The hub 11 may be connected (in a wired or wireless manner) to the processor.

The media file is loaded onto the PED. It will be appreciated that the software application 10a comprises instructions to manage the downloading process.

The software application 10b on determining that the media file has been loaded, is then operative to launch a media player on the PED. This may be incorporated as a module of the software application, and so there is no requirement to open a further application, either manually or under the control of the application, or a proprietary media viewer may be used which is installed on the PED. This functionality of rendering and outputting the media file could be implemented by way of a browser.

The software application 10b is configured to determine when a predetermined extent or time length of the media file has been rendered and output by the PED. This information may be attached or associated with the downloaded media file, or may be already stored in a memory of the PED at the time when the software application was initially installed or updated (or for example when the user loaded a boarding pass or similar onto the PED using the application), or otherwise subsequently.

On determining that a predetermined length of the media has been rendered and output, the software application is then configured to output a signal through the port 10d, which is indicative of this. This signal may include a credential of some kind, which the processor 5 can determine as being valid and may comprise a credential.

The signal may be compliant or conformant with a predetermined messaging/signalling protocol.

On receipt of the signal, and once any validation checks have been completed by or on behalf of the processor, the processor 5 is configured to control the switch 3 so as to connect the socket 3 to the power supply 4. The signal validation process may include comprise performing decryption methodologies on data in the signal and/or comparing the information delivered by the signal to a look-up table or similar of authorised codes/identifiers.

The software application 10a may be configured to permit a user to stop or pause the evolution of the rendered media prior to its scheduled completion or scheduled full running time or so as to allow a signal to be output which authorises the power supply to be operatively connected to the socket 2. This would require that at least a predetermined extent of the media's full running time has elapsed, and that the software application recognises that (a) the user has ceased evolution of the media and (b) the software application can determine when this takes place in relation to the minimum required running time. The software application 10a may display a prompt in a GUI which indicates to the user that the media can now be ceased and the charging or powering the device can begin. For example, the media may have a full running time of two minutes, but the user may be permitted to commence charging after a certain time has elapsed, such as thirty seconds. The prompt may include the text ‘Skip ad to start charging’ (or some such) and a displayed button which allows the user to provide an input.

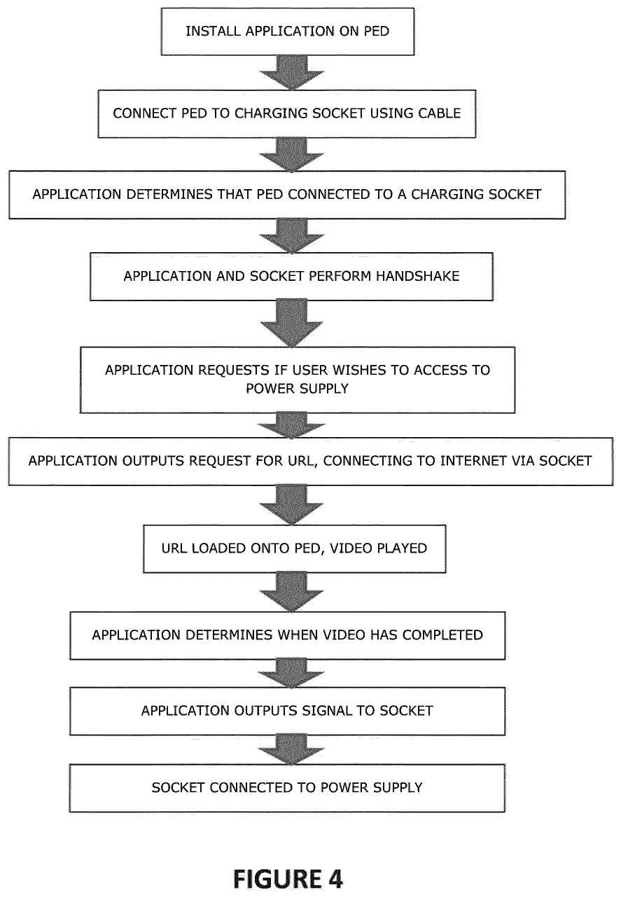

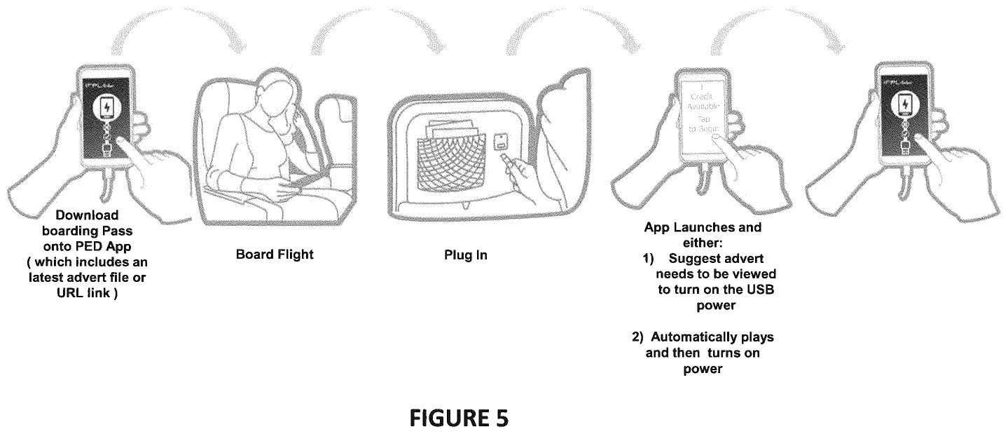

FIGS. 4 and 5 show the process implemented by the software application and the processor 5.

It should be appreciated that the URL need not be stored on the device 10, rather it may just be a credential of some kind which is relayed to a server, which can be validated and the corresponding media file can be identified/located and downloaded to the PED.

Instead of using a data connection through the socket to load the media, the media file could be pushed to the PED through a WLAN or Wi-Fi network.

As alluded to above, the media may be loaded and stored onto the device prior to connection to the onboard socket. By loading the app, the user agrees to the app having access to a specified amount of internal memory of the device 10. This means that the media (or link to media) may be downloaded in the background, for example using an update manager module, prior to boarding the aircraft. For example, each time that the user uses the app before boarding, the media file can be downloaded or updated. The user may access the app to check or update flight details, for example. (In the context of the media not being downloaded onto the device, but rather only a URL or identifier, then

In a similar vein, each time that the user connects to the onboard socket, an updated URL or the media, is loaded onto the device 10 for use the next time that the user plugs in. This covers the eventuality in which the next user may not have received an update or does not have the app, then power can nonetheless be activated.

The processor 5 may be configured to implement decryption processes for validating an (encrypted) credential or signal in order to activate a power supply.

Reference is made to FIG. 3 which shows how the arrangement of FIG. 1 could be implemented into a passenger seat 20. The USB power charging socket 2 and the contactless terminal 6 are conveniently provided in the armrest 25 of the seat 20. FIG. 4a also shows an in-seat power system (ISPS) unit, 4a, which regulates power supply for passenger at-seat use.

Advantageously, the application 10a may be an airline's authorised App, which for example allows customers to book flights, and view details of flights booked, to incorporate the charging functionality. The application may allow passengers to purchase tokens pre-flight, or be given tokens when a flight is booked.

Although the above description has focused on a token-based system for passengers to use a device charging facility through a (USB) socket, in addition or alternatively, such a token based credential system could be used to allow passengers (or users in other contexts/applications) access to a data connection, such as a connection to a data network such as the internet, or an intranet, through the wired physical connection provided by the (USB) socket, or a WLAN, such as Wi-Fi.

Brief mention is made above to inductive charging. This is in broad terms could involve the device playing the media, prior to outputting a signal to a controller or processor of an interface comprising an inductive charging point (such as a surface which contains an inductive charging loop) to indicate that the charging point can be energised.

Although reference is made in particular to charging a PED, this includes that a user may wish to use the device whilst it is charging.

1. Apparatus for controlling an interface for a portable electronic device, PED, the apparatus comprising a processor and a switch, and the switch arranged to control power supplied to the interface and/or a data connection via the interface, the processor configured to receive a signal and the processor arranged to control the switch to selectively determine to allow power and/or data to be delivered through the interface to a PED coupled to the interface, and the signal input comprises an indication of a media having been rendered and output by the PED.

2. Apparatus as claimed in claim 1 in which the processor requires that at least a predetermined proportion of the time length of the media is rendered and output before the processor can act so as to control the switch to allow connectivity to power and/or data through the interface.

3. Apparatus as claimed in claim 2 in which the processor is arranged to require that it receives a signal providing an indication of the at least predetermined portion having elapsed, or that it makes a determination of the same.

4. Apparatus as claimed in any preceding claim in which the processor is arranged to effect or participate in a handshake protocol of signalling or one or more messages or messaging exchanges with the PED so as to establish communication between the PED and the processor.

5. Apparatus as claimed in any preceding claim in which the processor configured to receive a signal indicative of a credential stored on or generated by the PED, in order to at least in part to cause the processor to control the switch.

6. Apparatus as claimed in any preceding claim in which the processor arranged to communicate with the PED by a wired or cable connection or physical carrier connected to the PED

7. Apparatus as claimed in any preceding claim in which the processor configured to permit access to a data network or data resource to allow the media to be downloaded onto a memory of the PED.

8. Apparatus as claimed in any preceding claim in which the processor is configured to process the signal to determine whether the signal corresponds to a valid credential.

9. Apparatus as claimed in any preceding claim in which the interface comprises a socket.

10. A passenger vehicle, which comprises a passenger seat, a connector port for connection to a portable electronic device, PED, of a passenger to be charged/powered or to be connected to a data connection provide through the interface, the connector port arranged at or in close proximity to the passenger seat, a control apparatus for controlling the interface, the control apparatus comprising a processor and a switch, the switch arranged to control power supplied to the connector port and/or a data connection via the interface, the processor arranged to receive a signal, and the processor configured to control the switch at least in part on dependence on the signal, and the signal indicative of a media having been rendered and output by the PED.

11. A software application for installation onto a user portable electronic device, PED, and the application arranged to cause the device to be capable of storing media or a link to media, and the application comprises instructions which cause the rendering of the media by the device, and further comprising instructions which determine when the media has been rendered, and so cause the device to output a signal which is indicative of that.

12. A software application as claimed in claim 11 which comprises instructions to determine when the PED is connected to a power interface to deliver power and/or to provide access to a data network or data resource.

13. A software application as claimed in claim 11 or claim 12 which comprises instructions to effect a messaging/signalling protocol, or handshake, to establish communication between the PED and the processor and/or to negotiate data and/or power access through the interface.

14. A software application as claimed in any of claims 11 to 13 which comprises instructions to access a data resource or data network to load a file of the media.

15. A software application as claimed in any of claims 11 to 14 which comprises instructions to generate a graphic user interface, GUI, which includes a prompt to a user to provide an input as to whether he/she would like to charge or power the device and/or access the data network.

16. A software application as claimed in any of claims 11 to 15 which comprises instructions to output a signal which is indicative of at least a predetermined portion or extent of the media is rendered by the device.

17. A software application as claimed in any of claims 11 to 16 which comprises a module for rendering audio-visual data.
